(19) United States
(12) Patent Application Publication
(10) Pub. No.: US 2006/0007670 A1
(43) Pub. Date: Jan. 12, 2006

(54) Head light kits for footwear

(76) Inventor: Tseng-Lu Chien, Shu-Chi Town (TW)

Correspondence Address: BACON & THOMAS, PLLC, 625 SLATERS LANE, FOURTH FLOOR, ALEXANDRIA, VA, 22314, US

(21) Appl. No.: 10/902,123

(22) Filed: Jul. 30, 2004

Related U.S. Application Data
(63) Continuation-in-part of application No. 10/883,741, filed on Jul. 6, 2004.
(63) Continuation-in-part of application No. 10/883,747, filed on Jul. 6, 2004.
(63) Continuation-in-part of application No. 10/883,719, filed on Jul. 6, 2004.

(51) Int. Cl. F21V 21/08

(52) U.S. Cl. 362/103

(57) ABSTRACT

The current invention disclosure a head light kits for footwear which may consist of a Plurality of super compact LED(s) installed on a flexible printing circuit board (hereafter as FPC) as a light means incorporated with sealing material and procedure to attached to the head portion of footwear. The said light means may be an electro-luminescent element (hereafter as EL). The light means connected with a switch to trigger the circuit to the power source which has batteries which may connected by any combination in-series and in-parallels to get different voltage and amperage to drive the different color LEDs or EL to get the best light effects and functions which create by the said circuit with desired electric components with predetermined function and time period.

This application is a continuation-in-part of U.S. patent application Ser. No. 10/883,741, filed Jul. 6, 2004 and Ser. No. 10/883,747, filed Jul. 6, 2004 and Ser. No. 10/883,719 filed on Jul. 6, 2004.

### BACKGROUND

The current invention related to have a super brightness light for front of the footwear to offer a illumination to the consumer especially for the aged peoples to walk at nighttime with very good illumination to prevent from any injury from nighttime waling for indoor and outdoor activities.

The current invention incorporated the super bright light emit diodes (hereafter as LED) or Electro-luminescent element as the light source.

The current invention relates to apply the Flexible Printing Circuit (hereafter as FPC) as a basic substrate material to install the dice or chip of LED element by bonding technical.

The Flexible Printing Circuit (FPC) having the features for bending, flexible, durable so can let the LED(s) well install on these copper area(s). The dice or the Chips of LED having the super compact dimension so allow people can have the super narrow and flexible LED(s) panel such as the Dice can have dimension less than 1.6 mm and Chips also less than 4×2.5 mm so can have super narrow LED(s) Band or Board for variety application which can not do before. It also can use the two conductive wires to install the said LEDs in-parallel, the conductive wires may have the isolating ink coating or isolating PVC coated as conventional market available material.

The Current invention apply the marketing place available LED in dice or chip form fixed on the FPC or two conductive wires to create the flexible, bendable, durable LED(s) light kits incorporated with Integrated circuit and switch means by weight to trigger the Integrated Circuit (hereafter as IC) for footwear which will prevent from the battery power consumption during the delivery which is major problem for prior art of the Mr. Nick Rogers and Mr. Wei etc. Both of the prior arts, the trigger by the vibration switch, then the integrated circuit will be start functions while the switch away from the contact-position or while the switch touch the contact-position. After the triggered, the light functions will last for a pre-determined time. The current invention make big improvement than all prior arts basing on the Push on-off switch triggered IC by weight and stop the function while the weight is away from the push on-off switch under pre-determined time.

Also, the current invention with special batteries arrangement for different voltage and amperage required by different colors LED(s). The co-inventor's prior art U.S. Pat. No. 5,599,088 disclosure plurality of batteries with combination of selection of connecting arrangement for desired voltage and amperage from in-series and in-parallel arrangement batteries.

The current invention incorporated a weather protection for the flexible printing circuit board by injection process or by envelope process to make the cosmetic appearance so the dice or chip of LED(s) will not see by the viewers. Only the super bright and attractive motion light effects been seen from viewers.

Further more, the current inventor prior art U.S. Pat. No. 5,879,069 teach the EL strips within a envelope, sleeve, injection piece to install on anywhere of the footwear. The current invention stating such device incorporated the press sensitive switch and integrated circuit to make for head light kits for footwear.

### FIGURE

FIG. 1: Disclosure the 1^{st} embodiment for a indoor slipper with preferred plurality of LED(s) on a FPC substrate as a light kits which incorporating the envelope-process to sealed the plurality of LED(s) within with eye-catching texture on the surface of the envelope.

FIG. 2: Disclosure the 2nd embodiment disclosure the plurality of LED(s) light kits with the proper spacing and the plurality of LED(s) on the surface of the substrate. The unit connected with the power pack which have build-in integrated circuit (hereafter as IC) to drive the LED(s) under predetermined function and duration. The push on and off switch connected between the circuit and LEDs to operate the circuit.

FIG. 3A to 3C: Disclosure the alternative models of the bending, flexible light kits and the features of different dimension of LED and conductive means or conductive substrate for the current invention.

FIG. 4: Disclosure the FIG. (1) light kits with details components with the hot sealing envelope to seal the Flexible Printing Circuit Board with Dice or Chip LED(s) on it and the circuit system.

FIGS. 5 and 6: Disclosure the FIG. (4) for the chip LED(s) and Dice LED(s) difference.

FIG. 7: Disclosure the alternative sealing process which is co-pending filing for double Injection sealing the EL panels series number of Ser. No. 10/621,513. This Fig. also disclosure the alternative sealing process which is use the Plastic compound may selected from the group of compound selected from the Silicone, Soft PVC, PVC sheet, PE sheet, PU sheet or the other conventional available soft plastic material for sealing procedure.

FIG. 8: Disclosure the preferable embodiment for sport sandal with head light kits.

FIG. 9: Disclosure the preferable embodiment for all other footwear including athletic shoe, hiker, casual shoe, camping shoe, mountain shoe, skate shoe, roller skate shoe, indoor slipper, outdoor sandal, functional shoe, army shoe whatever shoe which can let people to wear can install the head light kits on it with single or multiple switch system to turn on the light whenever the wear needed.

### DETAIL DESCRIPTION

The current invention mainly have the several technical to created the best LED(s) light kits for Head light kits for Footwear applications. The basic technical including
(1) Flexible Printing circuit board or the two pre-isolated conductive wires as substrate to install the super compact size LED elements
(2) Dice or Chip type of LED(s)
(3) Integrated circuit for LED(s) to offer the preferred functions with preferable trigger means by push on and off switch controlled by the weight applied to the said switch
(4) Proper sealing means applied to seal the FPC and LED(s) to make good appearance and cosmetic value
(5) Super narrow and compact size for the light unit
(6) Sealing means and process for the efficient for environment concern and durable quality.

The US prior art including Roger's U.S. Pat. No. 4,848,009, U.S. Pat. No. 5,343,190 and Weng's U.S. Pat. No. 5,663.614 and Wei's U.S. Pat. No. 6,525,487 and Anterby's U.S. Pat. No. 6,280,045,U.S. Pat. No. 6,354,712 and Wut's U.S. Pat. No. 6,104,140, U.S. Pat. No. 5,909,088, U.S. Pat. No. 5,866,987 and Goldston's U.S. Pat. No. 5,303,485, U.S. Pat. No. 5,546,681 and other prior arts including the U.S. Pat. Nos. 5,033,212, 5,329,432, 5,394,312, 5,371,662, 5,438,488, 5,456,032, 5,457,900 and U.S. Pat. No. 6,293,032 Waits, U.S. Pat. No. 5,930,921 Sorofman et al., U.S. Pat. No. 5,821,858 stone's did not apply the dice or chip size LED(s) on the flexible Printing circuit or did not incorporated with the current invention for push on and off switch to trigger the IC to create the light functions. The prior art have bulky traditional LED lacking of the flexible printing circuit board (or the equivalent function basic substrate).

The motion switch also created the power consumption during the delivery process to cause the power wasted. The current invention made big improvement for all those prior arts.

Basing on these features can created the best LED(s) head light kits for footwear application as follow introduction details features with details description:

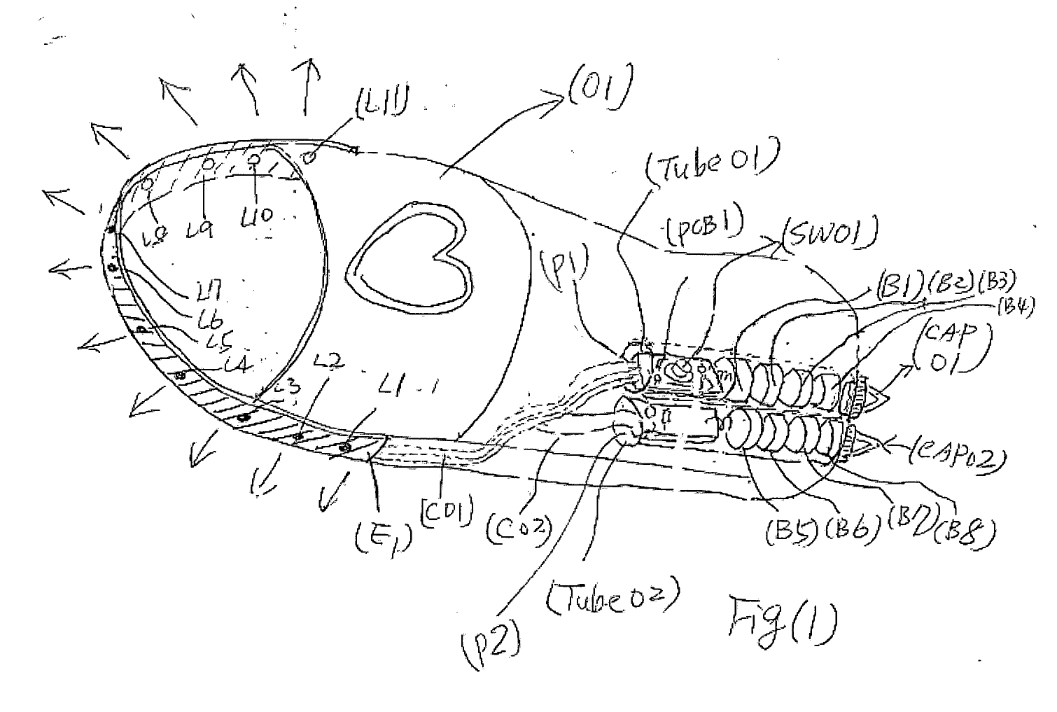

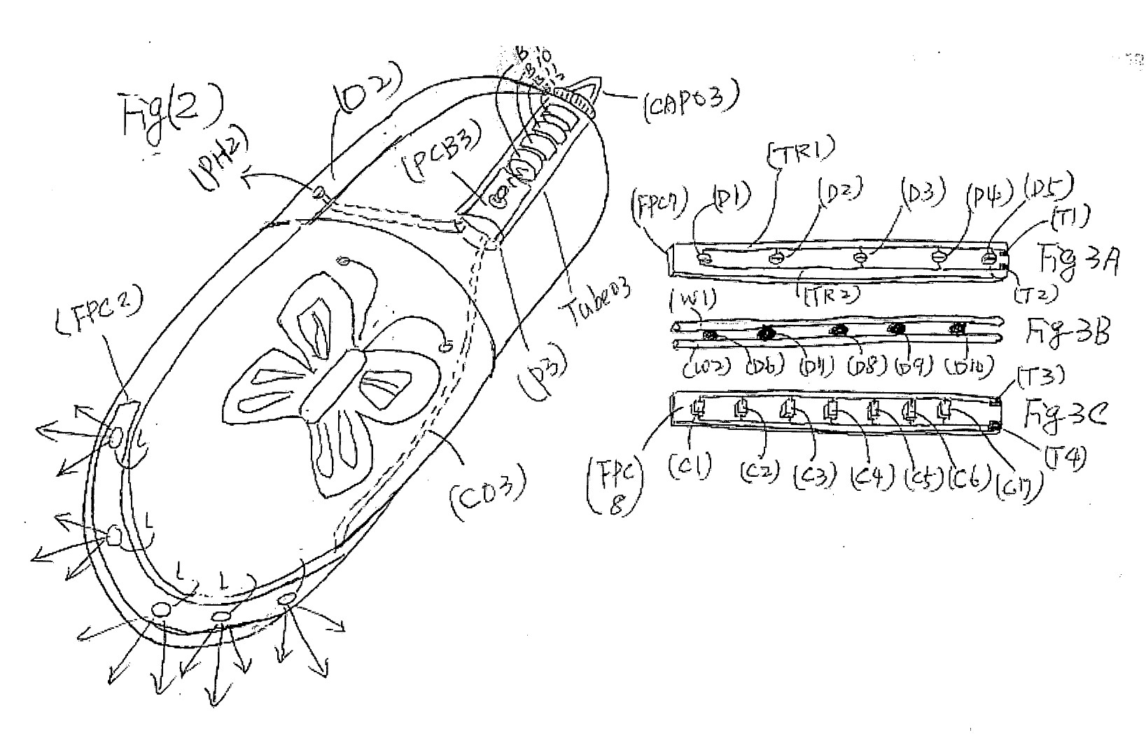

(1) Flexible printing circuit board of the modern technical, the each conductive trace may designed as narrow as possible for some applications. The trace width are less than the 0.1 mm incorporated with the dice type of LED will create the very narrow space needed for certain applications. For example the FIG. 1 the each lighted LED of the dice type plus the several conductive traces for each LED only less than 1.3 mm. Because the dice type of LED including the chemical sealing will not bigger than 0.5 mm to 2.0 mm. The chip type of LED with its sealing of the standard unit, the dimension only approximately 1.5 mm×2.0 mm. Hence, the conventional technical apply to the current inventor's prior art U.S. Pat. No. 5,722,757 will have big improvement by the new type of LED been available at market place. From FIG. 3B disclosure a new naked copper wire with pre-isolated treatment so can fix the dice LED(s) on two these naked copper wires. This also is new technical application basing on new LED development.

(2) The integrated circuit (hereafter as IC) incorporated with the press sensitive switch which may select from the group models from market place. This combination for the IC and the press sensitive switch can prevent from the power consumption during the delivery by truck, boat, and airplane. The earlier prior arts mainly to use a spring vibration switch which will have difficult to control the trigger possibility and cause the battery power lost during the delivery. It also will have big potential the spring for orientation precisely so the current invention preferred to use the press sensitive switch which can have different specification such as the switch will not connect together if the weight is no heavy than 30 kilograms (66 lbs) to prevent from the sitting still have the power consumption happen. All the specification will be decided by marketing requirement.

The Alternative switch may consideration or the multiple piece of switch can incorporated with the press sensitive switch.

It also can have the IC control while the Press Sensitive switch been connected for over period of time, then, the IC will turn off the circuit and wait for next time weight apply to the press sensitive switch. The current invention do not use the vibration switch to activate the said IC related to the contact-point as Nick's 009 and Wei's '487 and Weng's '614 prior arts.

From FIG. 1, disclosure the 1^{st} embodiment for a indoor slipper with plurality of LED(s) (L1 to 11) light on a flexible and bendable FPC substrate (not shown) and within a outside envelope (E1) which are made by preferred material may select from group combination of plastic, textile, metal, and any soft material so can allow the light kits for bending, flexible, twisted, and pulling.

The pieces of the flexible printing circuit (FPC1) (not shown) with plurality of the LED (LED1 to 11) installed on it and has desired arrangement of the copper traces of the flexible printing circuit (FPC 1) to deliver the electric signals from the circuit box (P1) to the LED(s) to make the said LED(s) with desired light functions and time period. The dice or chip LED(s) installation can use current inventor's earlier issued patent U.S. Pat. No. 5,746,500 arrangement for proper LED(s) installation and circuit designs.

It also can be see the alternative arrangement as FIG. 3A to FIG. 3C.

From FIG. 3A, the dice-type LED(s) (D1) (D2) (D3) (D4) (D5) are installed on the two traces (T1) (T2) of the flexible printing circuit board (FPC7) and all these dice-type LEDs are in-parallel. The each dice LED such as (D1) which only around 1.3 mm width so can use the very small width around 1.7 mm of flexible printing circuit board (FPC7) to save the cost of FPC material.

From FIG. 3-B, disclosure the two naked copper wires with painting on it and use special treatment to make the dice-type LEDs install on these naked copper wires. Because the copper wires are painted so it will not have any electric shortage issues. This arrangement for the naked copper wires with dice-LED fixed on it will save a lot of cost to make FPC tooling. It also have benefits while the spacing needed to be variable at any short time. This arrangement will overcome this problem too.

From FIG. 3C, this is same as FIG. 3A, But the all LED on this embodiment are the chip-type LED which have the common size around 2 mm (wide)×2.5 mm (length)×1.4 mm (high). This type of chip-LED has to have the other space for soldering two terminals so the min. length needed around 4-5 mm width. This is not the best choice than the FIG. 3A type but still is much better than the current conventional use the 3 mm×5 mm rigid piece of LED which can not have good cosmetic and appearance as current discussed FIG. 3A, 3B, 3C arrangement.

From FIG. 1, the LED (LED 1 to 11) preferred use the dice-type which can fix on the (FPC1) as tiny as possible such as 1.25 mm to 2 mm diameter after the epoxy sealing. The LED(s) (LED 1 to 11) and all related traces will be only have less than 3.0 mm width but can have all the desired functions, brightness, color, shape, size, dimensions, features so can apply to all kind of front area of different footwear. The current embodiment is for an indoor slipper front head. The all LED for this head light kits preferred to have the light beam been seen as steady burn as possible. This embodiment preferred to install switch means (SW01), circuit means (PCB1), box means (Tube01) inside the outsole. The batteries (B1) (B2) (B3) (B4) are well arranged inside the box (Tube 01) beside of the circuit means (PCB 1). The batteries can be connected for any combination of in-series and in-parallel as current inventor's earlier issued U.S. Pat. No. 5,599,088. The desired combination for plurality of the batteries in-series and in-parallel can create a different voltage and amperage for different LED(s) colors.

The (FPC1) are sealed within a thin plastic sheet with excellent textile and soft material with good color and light passing though capability. The envelope can be made in tube, pipe, cylinder, and flat sheet and use marketing conventional process to put the (FPC1) within the envelope. The (FPC1) may be shorter than the outside envelope so the wires can be hidden underneath the envelope.

The box means (Tube01) and (Tube02) both have the removable cap (Cap01) and (CapO2). These removable caps can allow the consumer to replace the batteries while the battery become empty after used. The box means (P1) have the housing (Tube01)

To have the circuit means (PCB1), switch means (SW01), batteries (B1) (B2) (B3) (B4) removable cap (cap01) and connected with the FPC by the conductive means (C01) to deliver the electric signals from the circuit means (PCB1) to the LED(s) (L1 to 11) for desired functions and time period. From FIG. 1, all the 11 piece of LED have its own light emitting direction and the light will have its own viewing angle normally from 5 to 60 degree from the center axis. Hence, proper arrangement for the LED orientation and location will cause the light beams make a very good arrangement to allow the aged people or kids walk under dark environment more safety. The current invention also have the most simple installation and assembly procedure than all prior art with super compact LEDs and super brightness flexible band type is big improvement for the footwear with head light kits. The current invention will make all dark environment activities become more safety. This head light kits for footwear can apply to all kind of footwear such as indoor slipper, outdoor sandal, sport sandal, athletic shoe, hiker, casual shoe, and any other footwear for people to wear.

The box means maybe can have more than one piece such as FIG. 1 disclosure the more than one piece. The more than 1 piece maybe required by marketing place for longer life before battery replacement, or any other consideration.

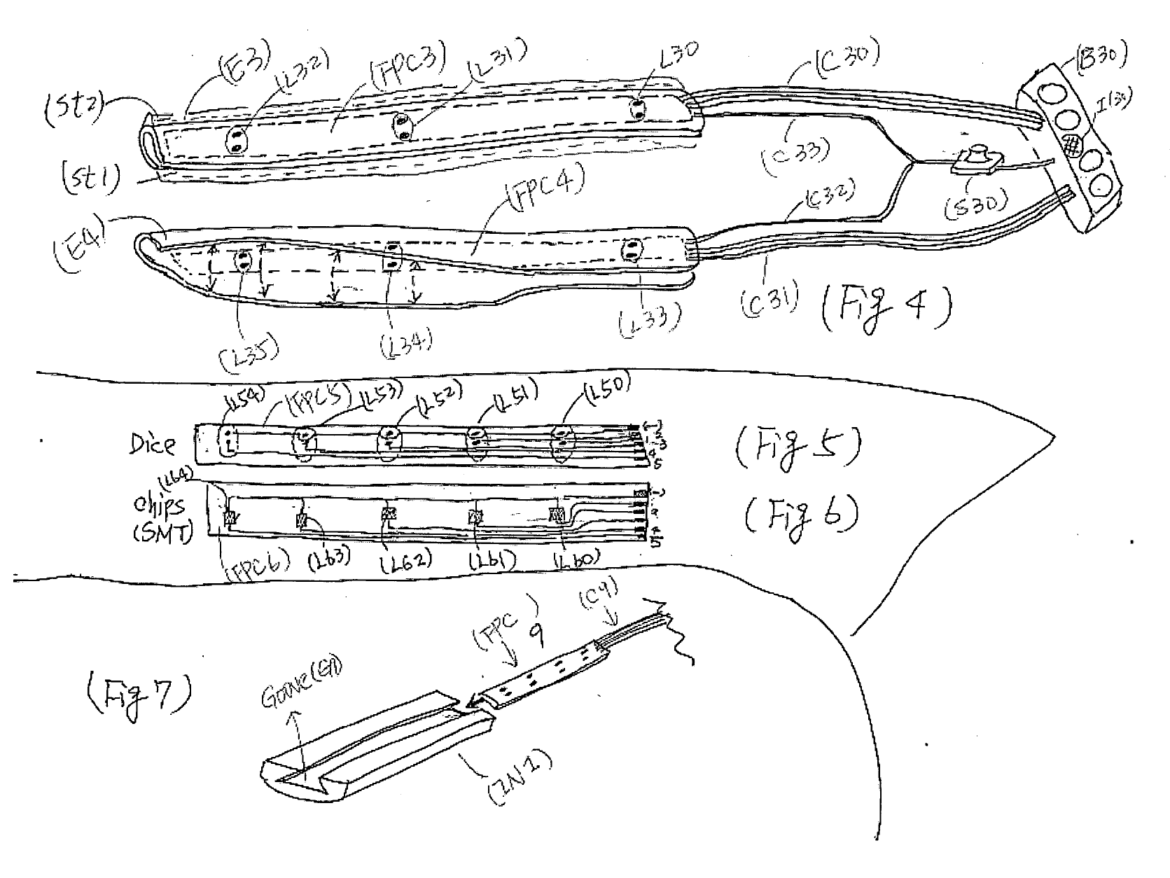

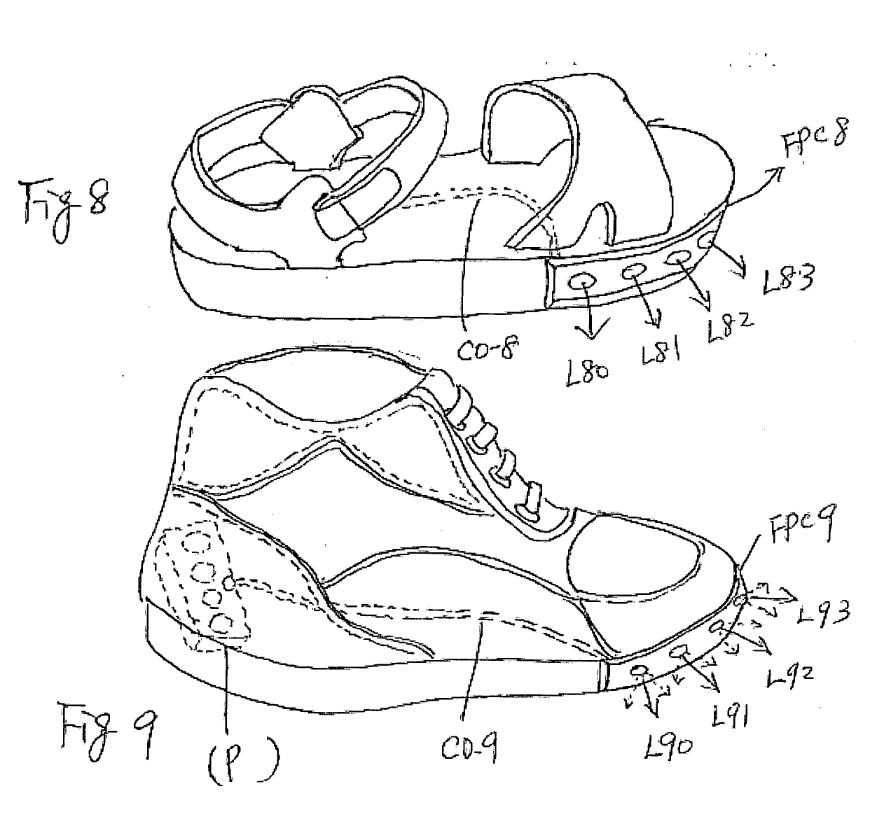

From FIG. 4, the material selection for the envelope (E3) (E4) can be selected from soft plastic material such as PU, PVC, PE, ABS, PC to allow easily assembly on the footwear head portion. The texture (not shown) of the envelope (E3) (E4) can be added to meet market requirement. The sealing method of the (FPC3) (FPC4) can use hot sealing of a foldable plastic sheet. It also can seal the (FPC9) by injection process as co-pending filing case series no: U.S. Ser. No. 10/621,513. From FIG. 7, It show the double injection process. The 1^{st} injection plastic part (IN1) with build in groove (G9) to allow the certain width elongate (FPC9) can slide into the groove wider bottom area and narrow upper portion will stop the (FPC9) to fall out while use the horizon injection machine. This arrangement will allow all plastic injection factories can do the injection as quickly as possible and no need to use the vertical injection machine which is expensive for labor and tooling. This embodiment is one of the examples, the 1^{st} injection part (IN1) is not limited have to with the wider bottom and narrow upper shape design. The any alternative method and design still within the scope of the current invention for injection sealing process.

From the FIG. 4, Disclosure the (FPC3) has LED (L30) (L31) (L32) fixed on it with the (E3) envelope to seal whole (FPC3). Same as the (FPC4) has LED(s) (L33) (L34) (L35) fixed on it with the (E4) envelope to sealed whole (FPC4). The envelope (E3) may have the stitch edges (ST1) and (ST2) for simple attach the head light kits on the footwear front portion without any problem. It also can apply the conventional attachment means such as glue, rivet, solvent, hook and loop, overlay, underlay treatment from conventional market place.

The (FPC3) and (FPC4) also can sealed within a textile material such as weaving tube or envelope or textile piece with additional sealing means which may selected from group combination of stitch, hot sealing, welding, melting, solvent, glue, double side tape, hook and loop, rivet, or the other equivalent process to allow the (FPC3) (FPC4) both can be fix on desired location of footwear. It also can sealed as the same inventor's prior art U.S. Pat. No. 5,746,500 but only the application is not limited for shoe lace but for all kind of applications such as footwear straps, strips, band, decoration tube, or the any place of the footwear.

The material for the envelope can be selected from group combination of material including plastic, chemical compound, textile, woods, metal in different geometric shape including sheet, tube, pipe, envelope, cylinder, elongated strip, string, band, strap, pocket, and folder in order to offer a space for FPC unit. For some applications, it not necessary to hold whole FPC unit within inside the said all kind of sealing means as above mentioned.

From the FIG. (5), disclosure the dice-type LED (L50) (L51) (L52) (L53) and (L54) fixed on the flexible substrate (FPC50). The each dice-type of LED has its owned terminal which can be soldered with other conductive means such as electric wires or ribbons to delivery the electric signals. This similar arrangement only need around 3.0 mm because each dice LED only need 0.5-2 mm width with extra 4-copper traces to deliver the electric signals to each LED so it can do very narrow to create a lot of application for footwear from shoe upper, bottom, lace, piping, decorative straps, band, strips and other properly arrangement.

From the FIG. (6), disclosure the chip-type of LED (L60) (L61) (L62) (L63) (L64) fixed on the flexible Printing circuit (FPC60). The each chip-type of LED has its owned terminals (−′) (1′) (2′) (3′) (4′) (5′) to allow connect with outside conductive means.

The market available chip dimension around 1.5 mm width×2.0 mm long so the chip-type LED need little wider than the chips type of LED. But this is still workable while we compare with epoxy sealed LED with 1 mm, 3 mm, 5 mm diameter for head and around 5-10 mm for body cylinder length.

From the FIG. (2), disclosure the Flexible Printing Board (FPC2) has geometric design.

The dice-type LED(s) are installed on the FPC (FPC20). The each LED (L20) (L21) (L22) (L23) (L24) are located on the FPC (FPC2) connected with the box means (P3) by conductive means (CO₃). The box means (P3) have its circuit means (PCB3) and tube means (Tube 03) and batteries (B9) (B10) (B11) (B12) and the removable cap (Cap 03). This will offer a very good wiring arrangement as the FIG. (2) only the two wires come out from the FPC (FPC20) to connect with box means (P3). The plurality of batteries (B9) (B10) (B11) (B12) have its arrangement for in-series and in-parallel so can get desired voltage and amperage to drive different LED units. The press sensitive can be designed to make connection while the weight is over fixed number, less weight will not make the electric connection as above mentioned and discussion.

Further, the light kits can incorporated with more control unit such as photo sensor (PH2) to control the head light will not turn on under the brighter light environment. This will save a lot of battery power. For some application for special footwear such as hiker for climb mountain or camping shoe etc, The 2^{nd} control unit may needed for special requirement such as hiker shoe the head lamp only turn on while the wear need this function.

From FIGS. 8 and 9, there show the different application for the head light kits for footwear which the footwear means is any footwear for people to wear. The head light kits can be install on the head portion of footwear by conventional attachment means and desired switch system to turn on the light kits as wear needed or design according to the market requirement for the circuit system.

From FIG. 8, The LED (L80) (L81) (L82) (L83) are arranged on a conductive means and attached on the front portion of the preferred embodiment (08). The conductive means may be a conductive wire, conductive FPC, conductive ink layer depend on the market requirement. The conductive means connected with the power source by wires (CO-08).

From FIG. 9, the LED (L90) (L91) (L92) (L93) are arranged on a Flexible Printed Circuit Board (FPC9) with its sleeve or envelope sealing means. The FPC (FPC9) connected with the power source (P09) by conductive means (CO-9).

The current invention mainly to offer a very compact size LED light device or EL light device to attached on the footwear head portion to offer a good illumination to let all people have good illumination under the dark environment for safety concern to prevent injury to peoples for indoor and outdoor activities.

Although, all preferred embodiments of the current invention are described in details. It will be appreciated that the scope of the invention is not to be limited to the described embodiments, but rather that the invention is to be interpreted in accordance with the appended claims.

1. A LED head light kits for footwear incorporated:
At least one substrate which is flexible material to offer a surface to install the said dice or chip type LED(s) on the surface with pre-designed conductive traces to deliver the electric signals to each of said LED for desired light functions and time period under pre-determined features.
At least one of circuit means to supply electric signals to LED(s) for desired functions and light effects and duration which triggered by the press sensitive switch by certain weight applied top of the said switch.
At least one of sealing material to seal the said substrate within, the said material may selected from group combination of plastic, chemical compound, textile, wood, metal in geometric shape incorporating with conventional sealing procedure may including of stitch, hot sealing, solvent, glue, double side tape, hook and loop, staple, rivet, melt, ultrasonic to allow the said substrate with LED(s) 1 be protected.
At least one of the conductive means to delivery the electric signals from the power source to LED(s).
At least one of power sources to offer the power to circuit means to make the circuit can be operated as desired functions incorporated the desired integrated circuit and batteries.
At least one fix means to install the said light kits on any location of footwear.
The improvement:
The batteries can be connected by group combination selected from in-series, in-parallel to allow circuit can drive the different color LED or LED(s).
Further more, the light desired function(s) may controlled by IC and the said IC is start to work while the weight is applied to the said press sensitive switch and the desired function(s) will be stop as predetermined time period while the weight is away from the said switch. The desired functions may selected from group combination of chasing, sequential, random flashing, all flashing, fade in and out, pair flashing and marketing conventional light function(s).

2. The LED head light kits for footwear as claimed (1), the footwear means may is any kind of the footwear for people to wear.

3. The LED head light kits for footwear as claimed (1), the LED or LED(s) means may selected from group of number, shape, illumination, dimension, colors, size, sealing, connection means with conductive means for the desired the said of light means.

4. The LED head light kits for footwear as claimed (1), the Integrated Circuit (IC) can have any combination of conventional functions incorporated the press sensitive switch to become a trigger means to drive the circuit for light function(s).

5. The LED head light kits for footwear as claimed (1), the attached means may selected from the group combination of glue, solvent, chemicals, hot sealing, ultrasonic sealing, double side, tape to seal the sealing material.

6. The LED head light kits for footwear as claimed (1), the basic substrate for intall of the tiny LEDs with all electric traces the width will less than the 15 mm.

7. The LED head light kits for footwear as claimed (1), the said IC or electric compoment(s) may install on the basic substrate.

8. The LED head light kis for footwear as claimed (1), the said IC incorporating a time counting device so can stop the circuit's power source if the light duration time is over pre-determined time period

9. The LED head light kits for footwear incorporated:
Plurality of LEDs are fixed on conductive means to connected with at least one switch and circuit means and power source, and install the said conductive means on the head portion of the said footwear for illumination.

10. The head Light kits for footwear incorporated:
At one light means are flexible and bendable to connected with at least one of switch means and circuit means and power source, and install the said flexible light means on the head portion of the said footwear for illumination.
